(19) United States
(12) Patent Application Publication
(10) Pub. No.: US 2024/0152915 A1
(43) Pub. Date: May 9, 2024

(54) SMART CONTRACT VERIFICATION

(71) Applicant: Oracle International Corporation, Redwood Shores, CA (US)

(72) Inventor: Jason Canney, Highlands Ranch, CO (US)

(73) Assignee: Oracle International Corporation, Redwood Shores, CA (US)

(21) Appl. No.: 17/981,697

(22) Filed: Nov. 7, 2022

(51) Int. Cl. G06Q 20/38; G06Q 20/06; G06Q 20/40

(52) U.S. Cl. CPC G06Q 20/3825; G06Q 20/065; G06Q 20/401

(57) ABSTRACT

Techniques for generating smart contract transaction data from a program embedded in the smart contract are disclosed. A distributed ledger system stores a smart contract specifying conditions of a transaction. Based on a user input to initiate the transaction, the system executes the smart contract transaction on the distributed ledger. A node executing the smart contract transaction executes the transaction verification program embedded within the smart contract. The transaction verification program includes instructions for transmitting the parameters of the transaction to a third party.

### TECHNICAL FIELD

The present disclosure relates to verifying execution of smart contract transactions in a distributed ledger environment. In particular, the present disclosure relates to executing a program stored in a smart contract upon execution of the smart contract transaction to notify another entity that the smart contract was executed.

### BACKGROUND

Goods bought and sold with digital currencies using distributed ledger technology, such as blockchain, execute smart contracts on the digital ledgers. The smart contracts record terms of the contract including costs associated with executing the contract. Smart contracts are typically set up such that they execute automatically, without user intervention, upon determining that the terms of the smart contract are met. For example, computers storing the smart contract may detect payment of a fee in a digital currency for goods and/or services. The computers storing the smart contract may further detect confirmation that goods and/or services were provided to purchasers. The executed smart contract is recorded in the distributed computers running the distributed ledger. Any user with access to the distributed ledger may view any transaction that was executed on the distributed ledger. For example, a vendor may identify transactions to execute the smart contract and transfer digital currency to record the sale of goods or services to customers.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for executing a smart contract transaction verification program in accordance with one or more embodiments;

FIG. 3 illustrates an example set of operations for evaluating transaction information in accordance with one or more embodiments;

FIG. 4 illustrates an example embodiment; and

FIG. 5 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. GENERATING SMART CONTRACT TRANSACTION DATA USING EMBEDDED PROGRAM
4. EVALUATING AND CLASSIFYING TRANSACTION DATA BASED ON VERIFICATION CRITERIA
5. EXAMPLE EMBODIMENT
6. COMPUTER NETWORKS AND CLOUD NETWORKS
7. MISCELLANEOUS; EXTENSIONS
8. HARDWARE OVERVIEW
1. GENERAL OVERVIEW

Smart contracts recorded in distributed ledger systems provide secure and reliable records of transactions. In particular, distributed ledgers, recording the terms of contracts across multiple independent ledgers in respective servers, ensure contract terms are known to the parties and are not altered by any party.

One or more embodiments execute a digital contract on a distributed ledger platform. The digital contract stores a digital contract transaction verification program. The system executes the digital contract responsive to receiving an instruction to initiate a transaction using a digital currency. Executing the digital contract includes (a) verifying the terms of the digital contract are satisfied, (b) storing the executed digital contract to the distributed ledger platform, (c) triggering execution of the digital contract transaction verification program stored in the digital contract, and (d) executing the digital contract transaction verification program to transmit transaction information to a designated entity.

The program causes one or more servers implementing the distributed ledgers (referred to herein as “distributed ledger nodes” or “nodes”) to transmit smart contract parameter data to a location or application indicated within the smart contract transaction verification program. For example, the program may identify an address of a target server storing an application that receives, stores, and evaluates smart contract transaction parameter data. The program may further include information associated with an application programming interface (API) of the application stored on the target server. The distributed ledger node initiates an API function call to transmit the smart contract transaction data to a location specified by the API function.

One or more embodiments transmit, by a distributed ledger node, the smart contract transaction data to a third party. In other words, the recipient of the smart contract transaction data may not be the customer or the vendor participating in the transaction. For example, a data management company may enter into a contract with a vendor to sell transaction data to other parties. The transaction data may provide information to the parties about what types of goods and services are being sold, how often, and to whom. The transaction data may indicate an effectiveness of an advertising campaign by tracking purchases resulting from selecting an electronic advertisement. The data management company may sell transaction data with tiered pricing, according to the reliability of the transaction data. For example, the data management company may sell transaction data received directly from a vendor at one price. The data management company may sell transaction data obtained from a smart contract transaction verification program at a higher price, since the data is only generated upon verification of a smart contract transaction by multiple nodes of a distributed ledger.

One or more embodiments described in this Specification and/or recited in the claims may not be included in this General Overview section.

2. System Architecture

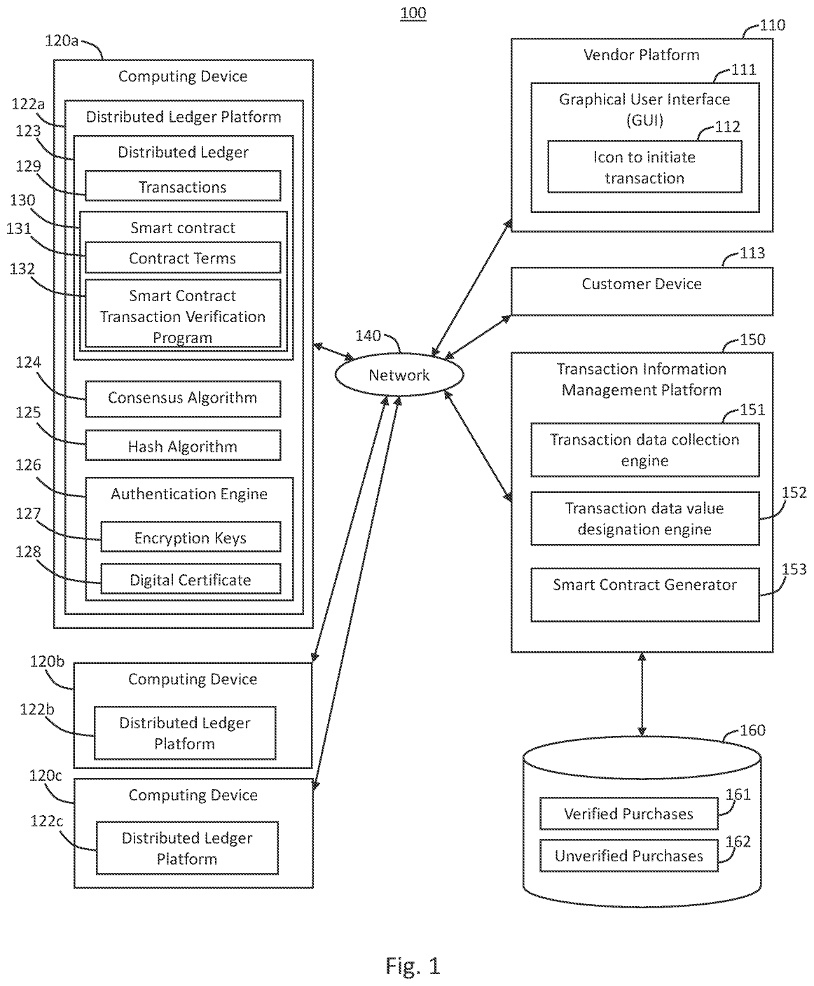

FIG. 1 illustrates a system 100 in accordance with one or more embodiments. As illustrated in FIG. 1, system 100 includes a vendor platform 110, a customer device 113, computing devices 120a and 120b, a transaction information management platform 150, and a data repository 160. The vendor platform 110, a customer device 113, computing devices 120a and 120b, and transaction information management platform 150 communicate via a network 140.

The computing devices 120a and 120b include a distributed leger platform 122a and 122b. In the present specification and claims, computing devices configured to implement distributed ledger platforms may be referred to as “distributed ledger nodes” or “nodes.” The distributed ledger platform 122a includes a distributed ledger 123, a consensus algorithm 124, a hash algorithm 125, and an authentication engine 126. Each of the distributed ledger platforms includes a respective distributed ledger, consensus algorithm, hash algorithm, and an authentication engine. The distributed ledger platforms 122a and 122b may be blockchain platforms. While only two computing devices 120a and 120b operating as distributed ledger nodes are illustrated in FIG. 1 for purposes of clarity in description, embodiments include any number of distributed ledger nodes, such as more than 100 nodes, and even more than 10,000 nodes.

The distributed ledger platforms 122a and 122b each store a distributed ledger 123. According to one embodiment, the distributed ledgers are blockchains. The distributed ledgers each store an identical set of records of modifications to maximum request rates for each entity with access to the shared resource 116. Each of the distributed ledger platforms 122a and 122b executes the same sequence of operations specified by a consensus algorithm to agree on a present state of the distributed ledger. In particular, the distributed ledger 123 records a sequence of transactions 129 and smart contracts 130. For example, the transactions 129 recorded in the distributed ledger may include transfers of money, transfers of data, and transfers of non-fungible tokens (NFTs). Smart contracts 130 include any program recorded in the distributed ledger. In embodiments described in the present application, smart contracts 130 are agreements between two or more parties. The smart contracts 130 include certain terms 131 defining the obligations of the parties to the contract. The terms 131 may include obligations to provide money or currency, services, products, and/or data. The smart contract 131 includes a smart contract transaction verification program 132 stored within the smart contract 130. Upon verification of the smart contract 130 by the computing devices 120a-120c (e.g., distributed ledger nodes), one or more of the computing devices 120a-120c executes the smart contract transaction verification program 132. The smart contract transaction verification program 132, when executed by the computing device 120a, causes the computing device 120a to generate contract transaction data and to transmit the data to the transaction information management platform 150. The computing device 120a may not be in communication with the transaction information management platform 150 when not executing the smart contract transaction verification program 132. In other words, prior to executing the smart contract transaction verification program 132, the computing devices 120a and 120b may be executing numerous different transactions on the distributed ledger 123. In addition, the computing devices 120a and 120b may not be aware of the destination address of the transaction information management platform 150 or the data that is to be sent to the transaction information management platform 150.

In one or more embodiments, the computing device 120a, based on executing the smart contract transaction verification program 132, further transmits smart contract transaction data to one or both of the vendor platform 110 and the customer device 113. The smart contract transaction verification program 132 may include a uniform resource locator (URL) with instructions for transmitting smart contract transaction data to a particular address specified by the URL. In the example illustrated in FIG. 1, the address is associated with the transaction information management platform 150. In addition, or in the alternative, the smart contract transaction verification program 132 may include a parameter that parties to the smart contract complete to execute the smart contract. The parameter may include an address to which a computing device 120a sends the smart contract transaction data. In addition, or in the alternative, the smart contract transaction verification program 132 may include one or more application programming interface (API) commands to allow the computing device 120a to transmit the smart contract transaction data to an application managed by the transaction information management platform 150.

Each of the distributed ledger platforms 122a and 122b executes the same sequence of operations specified by a consensus algorithm to agree on a present state of the distributed ledger 123. Examples of consensus algorithms include a proof of work (PoW) algorithm, a practical byzantine fault tolerance (PBFT) algorithm, a proof of stake (PoS) algorithm, a proof of burn (PoB) algorithm, and a proof of elapsed time (PoET) algorithm. In an embodiment in which the consensus algorithm 124 is a proof of work algorithm, one of the computing devices 120a and 120b solves a resource-intensive mathematical problem. Upon solving the resource-intensive mathematical problem, the particular computing device 120a or 120b announces a newly “mined” block, specifying the smart contract transaction, to be added to the distributed ledger to the other computing devices. According to an alternative example, in an embodiment in which the consensus algorithm 124 is a proof of elapsed time algorithm, each distributed ledger platform 122a and 122b waits a random amount of time prior to generating a block specifying a modification to an entity's maximum request rate. The distributed ledger platform 122a and 122b having the least timer value in a proof part validates the block. According to one or more embodiments, the smart contract 130 specifies an amount of digital currency to be paid to the distributed ledger node which first validates the block including the smart contract transaction.

The distributed ledger platform 122a includes a hash algorithm 125a. When posting ledger entries, including a record of the executed smart contract transaction, to the distributed ledger 123, the distributed ledger platforms 122a and 122b apply the hash algorithm 125a to the ledger entry data to generate a hash digest.

An authentication engine 126 generates authentication data to authenticate entities posting ledger entries to the distributed ledger. For example, when one of the distributed ledger platforms 122a or 122b authenticates a request to post a new ledger entry, the platform 122a or 122b generates an authentication credential including (a) a temporary symmetric key from the encryption keys 127a, (b) a hash digest based on the requested modification to a maximum request rate, and (c) a digital certificate 128a. The distributed ledger platform 122a or 122b broadcasts the authentication credential to each of the other distributed ledger platforms. The distributed ledger platform 122a or 122b encrypts the authentication credential with a public key, from among the encryption keys 127a, and transmits it to the distributed ledger platform 122a or 122b that requested the new ledger entry.

Each ledger entry in the distributed ledger 123 includes a hash of the data for the previous ledger entry. For example, an entry recording a smart contract 130 following a transaction 129 includes a hash of the preceding transaction. The entry recording the smart contract 130 also includes a hash of the smart contract 130.

An identical copy of the distributed ledger 123 is maintained by each node of the system. According to one or more embodiments, nodes in the system 100 are computing devices storing programs for maintaining a distributed ledger. While FIG. 1 illustrates three computing devices 120a and 120b as nodes in the system 100, embodiments include any number of nodes. For example, a public blockchain may include 10,000 or more nodes. Each time any node in the system generates a request to create a new ledger entry, the other nodes in the system validate the ledger entry. Each node then adds the new ledger entry to its respective distributed ledger 123. As a result, each node in the system 100 maintains a respective distributed ledger 123 with the same ledger entries as every other distributed ledger 123.

The system includes a vendor platform 110. The vendor platform 110 includes a graphical user interface 111 displaying an icon 112 to initiate a transaction. A user accesses the GUI 111 to select the icon 112 using a customer device 113 connected to the vendor platform 110 via the network 140. The vendor platform 110 includes any platform accessible by a customer via the network 140 to identify goods and/or services for purchase and to initiate a purchase. The vendor platform 110 may, for example, be a cloud-based platform including web pages stored in a cloud server. The vendor platform 110 may include in-house servers maintained by the vendor at a site controlled by the vendor. The vendor platform 110 may include a social media system generating advertisements for a vendor to initiate transactions between customers visiting social media sites and the vendor. A customer device 113 includes any type of digital device capable of accessing a remote server via the network 140. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a television, a content receiver, a set-top box, a printer, a mobile handset, a smartphone, a personal digital assistant (“PDA”), and/or a client device.

The transaction information management platform 150 receives transaction information from one or more sources, evaluates the transaction information. In some embodiments the transaction information management platform 150 provides the transaction information to other parties. For example, a transaction information management platform 150 may be a company that collects sales information for vendors or advertisers. The transaction information management platform 150 includes a transaction data collection engine 151 which obtains transaction data from transaction data sources. For example, when a vendor records a transaction for a good or service, the vendor may transmit transaction data, such as customer characteristics (e.g., zip code, purchasing profile), goods and/or items purchased, a date and time of purchase, and a purchasing mechanism, such as in-person, online via personal computer, and online via mobile device. A vendor may be a manufacturer or retailer of a good and/or service or a third-party vendor. The transaction information management platform 150 may re-sell transaction information to third parties. For example, a company may gather transaction information from many different sources and re-sell the transaction information to advertisers or vendors to help the advertisers or vendors maximize advertisement placements. A transaction data value designation engine 152 assigns a value to transaction data based on characteristics associated with the transaction data. For example, the transaction data value designation engine 152 may assign a relatively higher value to a verified purchase 161 than an unverified purchase 162. An example of a verified purchase is a transaction executing a smart contract on a distributed ledger, which is verified by the distributed ledger nodes. An example of an unverified purchase 162 is a record of a purchase obtained from a vendor, without any second-party verification of the purchase.

Records of verified purchases 161 and unverified purchases 162 may be stored in a data repository 160. In one or more embodiments, a data repository 160 is any type of storage unit and/or device (e.g., a file system, database, collection of tables, or any other storage mechanism) for storing data. Further, a data repository 160 may include multiple different storage units and/or devices. The multiple different storage units and/or devices may or may not be of the same type or located at the same physical site. Further, a data repository 160 may be implemented or may execute on the same computing system as the transaction information management platform 150. Alternatively, or additionally, a data repository 104 may be implemented or executed on a computing system separate from the transaction information management platform 150. A data repository 160 may be communicatively coupled to the transaction information management platform 150 via a direct connection or via a network.

Information describing verified purchases 161 and unverified purchases 162 may be implemented across any of components within the system 100. However, this information is illustrated within the data repository 160 for purposes of clarity and explanation.

The transaction information management platform 150 may further include a smart contract generator 152. According to one or more embodiments, the transaction information management platform 150 creates, for a vendor, a smart contract specifying conditions of a transaction and including the smart contract transaction verification program 132. According to one example embodiment, the smart contract transaction verification program 132 includes instructions to direct transaction information of a verified smart contract execution transaction to the transaction data collection engine 151. The instructions may include a uniform resource locator (URL) to cause a computing device 120a and/or 120b to direct the smart contract execution transaction information over the network 140 to the transaction information management platform 150. In addition, or in the alternative, the instructions may include application programming interface (API) function data to cause a computing device 120a and/or 120b to perform an API function call to the transaction data collection engine 151 to provide the transaction data to the transaction data collection engine 151. The vendor or the transaction information management platform 150 may record the smart contract in the distributed ledger platform.

Additional embodiments and/or examples relating to computer networks are described below in Section 6, titled “Computer Networks and Cloud Networks.”

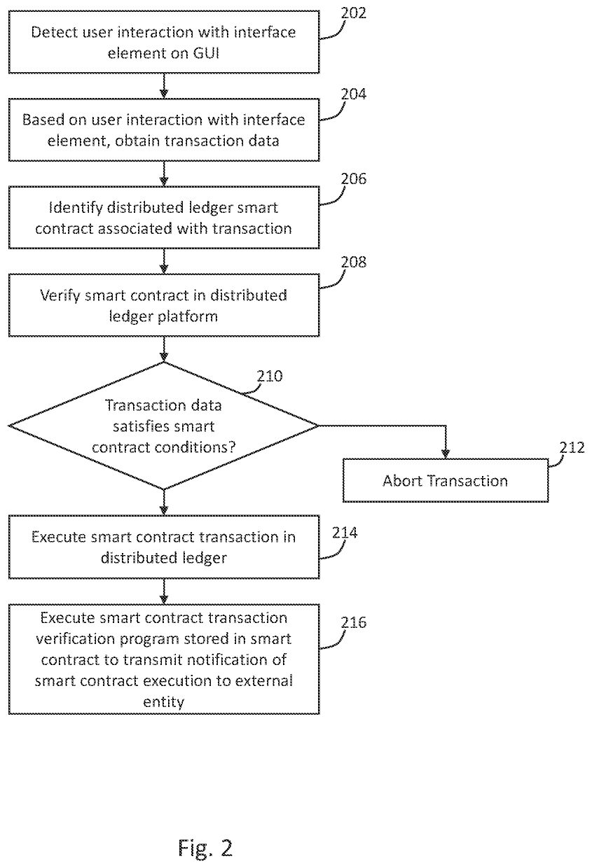

In one or more embodiments, a transaction information management platform 150 refers to hardware and/or software configured to perform operations described herein for collecting transaction data from vendors, advertisers, and/or customers and from smart contract transaction verification programs. The transaction information management platform 150 further refers to hardware and/or software configured to perform operations described herein for evaluating the transaction data, assigning values to the transaction data, and generating smart contracts. Examples of operations for generating smart contracts and evaluating data obtained by smart contract transaction verification programs are described below with reference to FIG. 2.

In an embodiment, the computing devices 120a-120c, the vendor platform 110, the customer device 113, and the transaction information management platform 150 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, interface 111 refers to hardware and/or software configured to facilitate communications between a user and the vendor platform 110. Interface 111 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 111 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 111 is specified in one or more other languages, such as Java, C, or C++. While not illustrated in FIG. 1, each of the computing devices 120a and 120b, the customer device 113, and the transaction information management platform 150 further includes an interface including hardware and/or software configured to facilitate communications between a user and the computing devices 120a and 120b, the customer device 113, and the transaction information management platform 150, respectively.

3. Generating Smart Contract Transaction Data Using Embedded Program

FIG. 2 illustrates an example set of operations for generating and transmitting smart contract transaction data using a program embedded in the smart contract in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

A system detects a user interaction with an interface element of a graphical user interface (Operation 202). The user interaction corresponds to a selection to initiate a transaction. For example, a user browsing a web page over the network may select an advertisement. Selection of the advertisement may cause the system to initiate a transaction by displaying a transaction page including fields for a user to complete to describe a quantity of a selected good to be purchased. The transaction page may further include terms of the transaction, such as an option to complete the transaction with a cryptocurrency or another digital asset recorded on a distributed ledger.

Based on the user interaction with the interface element, the system obtains transaction data (Operation 204). Transaction data includes customer identification information, vendor identification information, identification information associated with a good/service being purchased, a delivery location for a good/service (including a physical address or an electronic address to send digital content), a price to be paid for the good/service, a payment method, such as credit card, bank information, crypto-wallet information, or third-party payment information.

The system identifies a distributed ledger smart contract associated with the transaction (Operation 206). The distributed ledger smart contract is a program stored in a distributed ledger, such as a blockchain. The distributed ledger is an identical record of a sequence of transactions and programs. The sequence of transactions and programs is recorded across multiple different ledger nodes, such as computers and servers. The smart contract is a program stored in the distributed ledger specifying terms of a transaction. Upon execution of the smart contract, distributed ledger nodes execute a smart contract transaction and record the transaction in the distributed ledger.

The system determines whether the transaction data satisfies the conditions of the smart contract (Operation 210). For example, the system may identify a delivery location for a good/service, a selected payment type for the good/service, and a payment source. For example, if the smart contract specifies the transaction is to be paid for with cryptocurrency, the system may request verification from a specified blockchain that the specified funds are available.

If the system determines that the smart contract conditions have not been satisfied, the system aborts the transaction (Operation 212). The system may notify one or both of the vendor and the customer that the transaction failed. In addition, the ledger nodes do not record any transaction in the distributed ledger.

If the system determines that the smart contract conditions are satisfied, the system executes a transaction specified by the conditions in the smart contract in the distributed ledger (Operation 214). Executing the smart contract transaction includes obtaining fuel, typically a digital currency, to execute the smart contract transaction. The smart contract may further specify payment to-be-performed or payment already performed. According to one example, the smart contract specifies payment in a cryptocurrency. Execution of the smart contract may include transfer of the cryptocurrency from a customer account to a vendor account. Transfer of the cryptocurrency includes recording the transfer on the distributed ledger.

A system device provides the smart contract data obtained by one or both of a customer and a vendor to a distributed ledger system. For example, the system device may initiate on a blockchain a new smart contract transaction by executing the smart contract previously stored on the blockchain. The distributed ledger nodes validate the smart contract transaction. Each distributed ledger node in a distributed ledger system executes a consensus algorithm to agree on a present state of the distributed ledger including the smart contract transaction. Examples of consensus algorithms include a proof of work (PoW) algorithm, a practical byzantine fault tolerance (PBFT) algorithm, a proof of stake (PoS) algorithm, a proof of burn (PoB) algorithm, and a proof of elapsed time (PoET) algorithm. For example, according to one embodiment in which the consensus algorithm is a proof of work algorithm, one of the distributed ledger nodes solves a resource-intensive mathematical problem. Upon solving the resource-intensive mathematical problem, the particular distributed ledger node announces a newly “mined” block, specifying the smart contract transaction, to be added to the distributed ledger to the other computing devices. The smart contract specifies an amount of cryptocurrency to be paid to the distributed ledger node which mines the block including the smart contract transaction.

Upon validating the smart contract transaction, the distributed ledger nodes apply a hash algorithm to the new block to generate a hash digest. The hash digest is included in the new block and in a subsequent block.

The system executes a smart contract transaction verification program stored in the smart contract (Operation 216). The smart contract transaction verification program includes instructions to transmit specified smart contract transaction data to a specified address. The smart contract transaction verification program may include a uniform resource locator (URL) to cause a distributed ledger node to direct smart contract transaction data over a network to a specified entity. In addition, or in the alternative, the smart contract transaction verification program may specify an application programming interface (API) function data to cause a distributed ledger node to perform an API function call to a specified entity to provide the transaction data to the specified entity.

According to one or more embodiments, the smart contract verification program includes instructions to transmit specified smart contract transaction data to a specified address associated with at least one entity that is not the customer or the vendor. For example, the smart contract verification program may include instructions to transmit specified smart contract transaction data to a service provider that tracks and sells transaction data and/or customer demographic data to advertisers and/or vendors. The smart contract verification program may also include instructions to transmit specified smart contract transaction data to one or both of the vendor and/or the customer.

4. Evaluating and Classifying Transaction Data Based on Verification Criteria

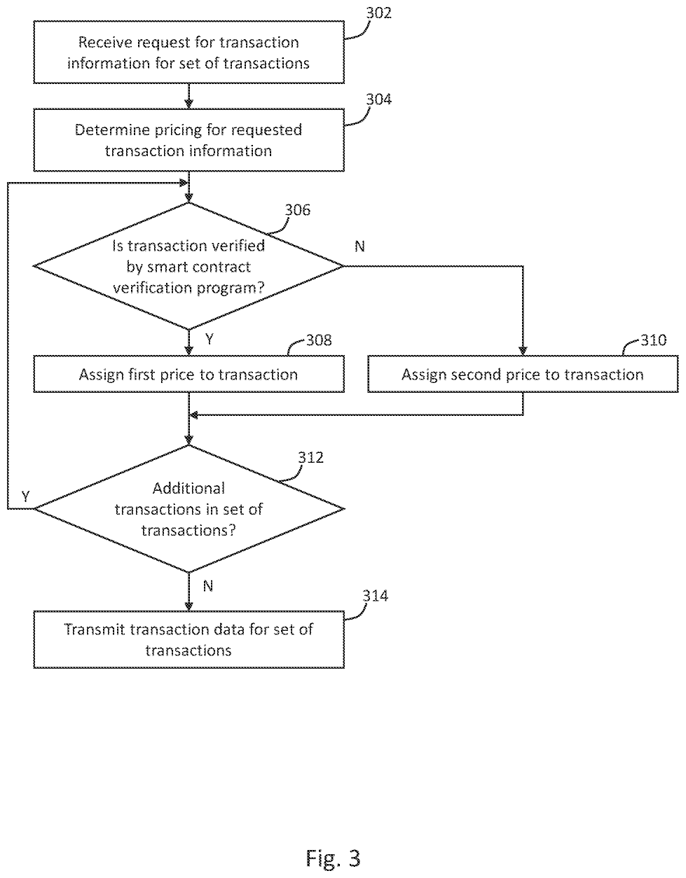

FIG. 3 illustrates an example set of operations for evaluating and classifying transaction data, including data from smart contract transactions, based on verification criteria, in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments.

A system receives a request for transaction information for a set of transactions (Operation 302). For example, an advertiser may request demographic information for customers accessing a particular vendor website. In addition, or in the alternative, a vendor may request demographic information associated with a particular product. The request may include particular criteria, such as: a particular amount of data, a particular price for the data, a particular level of reliability for the data, and a specification of a particular source of the data.

The system identifies and evaluates a set of transaction data associated with the request to determining pricing for the set of transaction data (Operation 304). For example, a set of transaction data associated with purchases associated with a particular third-party website (e.g., not the vendor's site, but a site on which an advertisement for the vendor is displayed) includes transactions associated with smart contracts paid for by cryptocurrency and transactions paid for by conventional government-backed currencies. Transaction information may vary in value based on the reliability of the transaction information. According to one embodiment, transaction information that has been verified by a distributed ledger is more valuable than transaction information obtained from a vendor or an advertiser. Transaction information obtained from a vendor or advertiser may include transaction information that corresponds to a pending transaction, for which payment has been authorized but which has not yet been transferred by a financial institution. In other words, there may be a delay between a time when a transaction is initiated and recorded by a vendor and when a bank or financial institution clears funds to be transferred to the vendor. In contrast, a transaction verified by a distributed ledger may involve a transfer of digital assets, such as cryptocurrencies, which are transferred in real-time and recorded in the distributed ledger. Upon executing the smart contract transaction, one or more distributed ledger nodes execute a smart contract transaction verification program stored in the smart contract. The program causes the distributed ledger node to transmit the transaction verification data to a transaction data evaluation component within the system, such as an entity that receives, evaluates, classifies, and sells or distributes transaction data. Accordingly, the system may value transaction information associated with a verified smart contract transaction higher than transaction information obtained from a vendor or advertiser directly. The system may determine that the transaction information associated with the verified smart contract is likely to be more reliable, more timely, and/or more accurate than transaction information obtained directly from a vendor and/or advertiser.

The system determines whether transaction information is from a validated smart contract or from another source (Operation 306). Based on determining that the transaction information is from a validated smart contract, such as from a distributed ledger node which executed a smart contract transaction program, the system classifies the transaction in a relatively higher tier associated with transaction data that is relatively more valuable. The system assigns a first, relatively higher price to the transaction information (Operation 308). Based on determining that the transaction information is from a source other than a verified smart contract, such as from a vendor or advertiser, the system classifies the transaction in a relatively lower tier associated with transaction data that is relatively less valuable. The system assigns a second, lower price to the transaction information (Operation 310).

The system determines whether additional transactions remain to be analyzed until an entire set of transaction is evaluated (Operation 312).

Based on determining that no additional transactions remain to be evaluated, the system prepares a set of transaction data corresponding to the request. The system transmits the prepared set of transaction data in response to the request (Operation 314).

For example, an advertiser may request from a customer demographic evaluation service a set of data of a particular size, at a particular price, associated with customers of a particular vendor platform. The system identifies any transactions associated with customers of the particular vendor platform. The system identifies a first set of transactions associated with verified smart contract transactions and a second set of transactions associated with transactions which were not verified smart contract transactions. Based on the price specified by the advertiser, the customer demographic evaluation service provides to the advertiser a mix of transaction data from the first set and the second set of transaction data according to the specified price.

According to another example, a customer demographic evaluation service may prepare sets of transaction data with set prices, reliability values, transaction types, and demographics. The customer demographic evaluation service may prepare two sets of transaction data associated customers within particular age ranges purchasing products at particular prices. A first set of data, valued at a higher price than the second set, includes a higher ratio of verified smart contract transaction data to non-verified data obtained directly from vendors or advertisers. The second set of data, valued at a lower price, includes a lower ratio of verified smart contract transaction data to non-verified data.

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

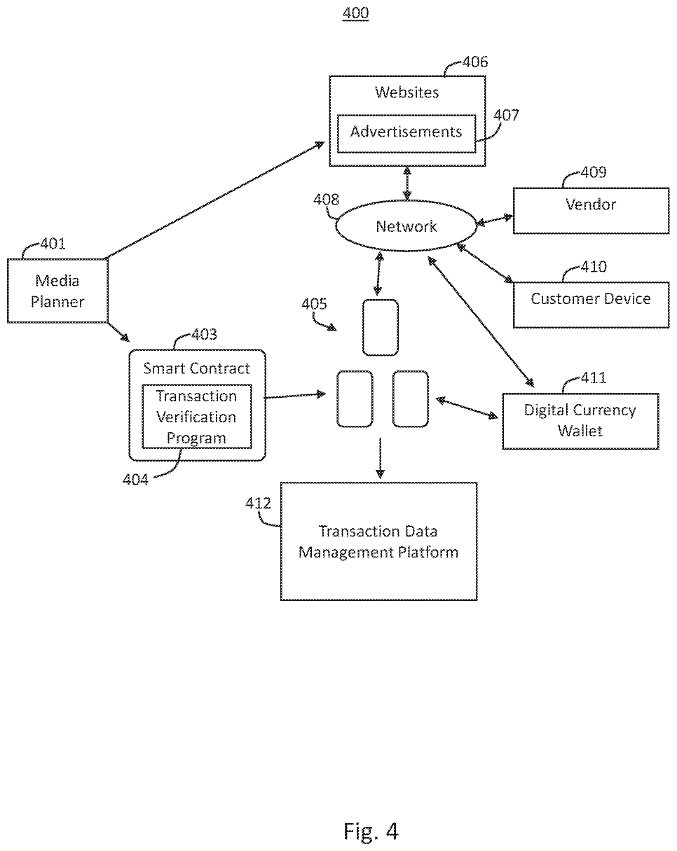

FIG. 4 illustrates a system 400 for generating smart contract transaction verification data. A media planner 401 creates an ad campaign. For example, a vendor 409 may request the media planner 401 create an ad campaign for a particular product. The media planner 401 creates advertisements for particular electronic platforms, such as specified websites 406. The advertisements 407 include, for example, search engine marketing ads, display advertising, social media advertising, and email advertising.

The media planner 401 also creates a smart contract 403 that is executed by interaction of a user with advertisements 407 designed and implemented by the media planner 401. A vendor 409 may specify conditions of the smart contract 403, including price, a type of cryptocurrency that will be permitted to execute a transaction using the smart contract, and a product associated with the smart contract 403. The media planner 401 further programs a smart contract transaction verification program 404 into the smart contract 403. The smart contract transaction verification program 404 includes instructions and destination information for sending smart contract transaction data upon execution and validation of the smart contract transaction. In the embodiment illustrated in FIG. 4, distributed ledger nodes in the distributed ledger platform 405 store the smart contract 403. In addition, in the embodiment illustrated in FIG. 4, at least one distributed ledger node which validates the smart contract transaction executes the smart contract transaction verification program to generate and transmit transaction data to the transaction data management platform 412.

A customer uses the customer device 410 to access the websites 406 via the network 408. Upon interacting with an advertisement 407, the advertisement 407 initiates a transaction between the vendor 409 and the customer device 410. In particular, interaction with the advertisement 407 prompts the customer device 410 to provide information corresponding to the terms of the smart contract 403. According to one embodiment, interaction with the advertisement 407 directs the customer device 410 to a new web page for receiving transaction parameters from the customer and/or the vendor 409 to initiate a smart contract transaction. The customer provides transaction parameters, such as a number and type of good/service desired. The advertisement program specifies a cost of the goods/services requested by the customer and a payment type required. The system confirms the values provided by the customer comply with the conditions of the smart contract.

The system executes a transaction in the distributed ledger system 405 based on the smart contract 403 stored in the distributed ledger. The distributed ledger system 405 initiates a smart contract validation and generates a new block in the distributed ledger corresponding to the smart contract transaction. The distributed ledger system 405 initiates a cryptocurrency from the customer's cryptocurrency account. For example, the customer may provide access to a cryptocurrency wallet 411 which includes a secure key to allow the distribute ledger system 405 to transfer cryptocurrency from a customer's balance to a vendor's balance. The transaction transferring the cryptocurrency is recorded in the distributed ledger. In addition, the distributed ledger system 405 obtains a cost associated with validating the transaction on the distributed ledger. For example, the distributed ledger system 405 may reward the particular distributed ledger node which first validated the smart contract transaction with a specified amount of cryptocurrency. An identical block describing the smart contract transaction is stored in each node of the distributed ledger system 405.

Once the smart contract transaction is validated, one or more nodes of the distributed ledger system 405 execute the smart contract transaction verification program 404 stored in the smart contract. The smart contract transaction verification program 404 includes one or both of an address, such as a URL, and an API function description to allow a distributed ledger node to transmit transaction data to the transaction data management platform 412. The transaction data management platform 412 stores the transaction data. The transaction data management platform 412 may also perform analytics on the transaction data to identify purchasing patterns of customers across different demographics. The transaction data management platform 412 may sell the transaction data and/or the analytics to advertisers and/or vendors. For example, a vendor who wants to target a particular demographic of customer with a particular product may request transaction data analytics identifying which customers are most likely to click through an advertisement and then purchase a product. The transaction data management platform 412 may sell the analytics data in a tiered structure, assigning a higher value to transaction data obtained from a transaction verification program associated with a smart contract transaction.

6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

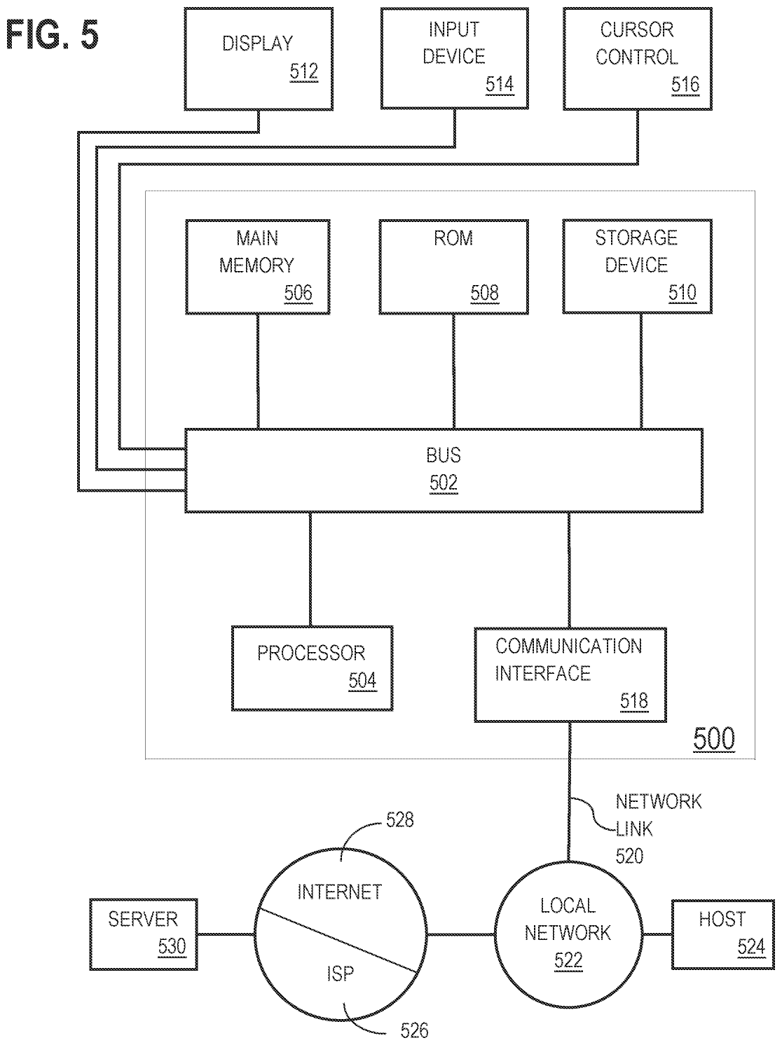

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which,
when executed by one or more hardware processors, causes performance of operations comprising:
receiving an instruction to initiate a transaction using a digital currency;
responsive to receiving the instruction, executing a digital contract on a distributed ledger platform,
wherein the digital contract specifies terms of the transaction,
wherein the digital contract stores a digital contract transaction verification program, and wherein executing the digital contract comprises:
verifying the terms of the digital contract are satisfied;
responsive to verifying the terms of the digital contract are satisfied:
storing the executed digital contract to the distributed ledger platform;
triggering execution of the digital contract transaction verification program stored in the digital contract; and
executing the digital contract transaction verification program stored in the digital contract to transmit transaction verification information to a designated entity.

2. The non-transitory computer readable medium of claim 1, wherein the digital currency is a cryptocurrency.

3. The non-transitory computer readable medium of claim 1, wherein executing the transaction verification program stored in the digital contract to transmit the transaction verification information to the designated entity includes transmitting the transaction verification information to an address specified in a uniform resource locator (URL) specified in the digital contract.

4. The non-transitory computer readable medium of claim 1, wherein executing the transaction verification program stored in the digital contract to transmit the transaction verification information to the designated entity includes executing a command of an application programming interface (API) associated with the entity to receive the verification information as an application input parameter.

5. The non-transitory computer readable medium of claim 1, wherein the digital contract specifies a first entity associated with payment of a specified price and a second entity associated with providing a specified product or service, and
wherein the designated entity is not one of the first entity and the second entity.

6. The non-transitory computer readable medium of claim 1, wherein the operations further comprise:
receiving, by the entity, first transaction data associated with a first transaction, the first transaction data including first transaction verification information specifying a first set of transaction attributes;
receiving, by the entity, second transaction data associated with a second transaction, the second transaction data specifying the first set of transaction attributes;
responsive to determining that the first transaction data includes first transaction verification information generated by a first transaction verification program stored in a first digital contract: assigning a first value to the first transaction data; and
responsive to determining that the second transaction data (a) includes transaction information associated with a second digital contract, and (b) does not include any transaction verification information generated by any transaction verification program stored in the second digital contract: assigning a second value to the first transaction data,
wherein the first value is greater than the second value.

7. The non-transitory computer readable medium of claim 1, wherein the transaction is a sale of goods or services in exchange for a specified amount of a digital currency.

8. The non-transitory computer readable medium of claim 1, wherein the transaction is a fee charged in a digital currency based on detecting a user interaction with an advertisement.

9. A method comprising:
receiving an instruction to initiate a transaction using a digital currency;
responsive to receiving the instruction, executing a digital contract on a distributed ledger platform,
wherein the digital contract specifies terms of the transaction,
wherein the digital contract stores a digital contract transaction verification program, and wherein executing the digital contract comprises:
verifying the terms of the digital contract are satisfied;
responsive to verifying the terms of the digital contract are satisfied:
storing the executed digital contract to the distributed ledger platform;
triggering execution of the digital contract transaction verification program stored in the digital contract; and
executing the digital contract transaction verification program stored in the digital contract to transmit transaction verification information to a designated entity.

10. The method of claim 9, wherein the digital currency is a cryptocurrency.

11. The method of claim 9, wherein executing the transaction verification program stored in the digital contract to transmit the transaction verification information to the designated entity includes transmitting the transaction verification information to an address specified in a uniform resource locator (URL) specified in the digital contract.

12. The method of claim 9, wherein executing the transaction verification program stored in the digital contract to transmit the transaction verification information to the designated entity includes executing a command of an application programming interface (API) associated with the entity to receive the verification information as an application input parameter.

13. The method of claim 9, wherein the digital contract specifies a first entity associated with payment of a specified price and a second entity associated with providing a specified product or service, and
wherein the designated entity is not one of the first entity and the second entity.

14. The method of claim 9, further comprising:
receiving, by the entity, first transaction data associated with a first transaction, the first transaction data including first transaction verification information specifying a first set of transaction attributes;
receiving, by the entity, second transaction data associated with a second transaction, the second transaction data specifying the first set of transaction attributes;
responsive to determining that the first transaction data includes first transaction verification information generated by a first transaction verification program stored in a first digital contract: assigning a first value to the first transaction data; and
responsive to determining that the second transaction data (a) includes transaction information associated with a second digital contract, and (b) does not include any transaction verification information generated by any transaction verification program stored in the second digital contract: assigning a second value to the first transaction data,
wherein the first value is greater than the second value.

15. The method of claim 9, wherein the transaction is a sale of goods or services in exchange for a specified amount of a digital currency.

16. The method of claim 9, wherein the transaction is a fee charged in a digital currency based on detecting a user interaction with an advertisement.

17. A system comprising:
one or more processors; and
memory storing instructions that, when executed by the one or more processors, cause the system to perform:
receiving an instruction to initiate a transaction using a digital currency;
responsive to receiving the instruction, executing a digital contract on a distributed ledger platform,
wherein the digital contract specifies terms of the transaction,
wherein the digital contract stores a digital contract transaction verification program, and
wherein executing the digital contract comprises:
verifying the terms of the digital contract are satisfied;
responsive to verifying the terms of the digital contract are satisfied:
storing the executed digital contract to the distributed ledger platform;
triggering execution of the digital contract transaction verification program stored in the digital contract; and
executing the digital contract transaction verification program stored in the digital contract to transmit transaction verification information to a designated entity.

18. The system of claim 17, wherein the digital currency is a cryptocurrency.

19. The system of claim 17, wherein executing the transaction verification program stored in the digital contract to transmit the transaction verification information to the designated entity includes transmitting the transaction verification information to an address specified in a uniform resource locator (URL) specified in the digital contract.

20. The system of claim 17, wherein executing the transaction verification program stored in the digital contract to transmit the transaction verification information to the designated entity includes executing a command of an application programming interface (API) associated with the entity to receive the verification information as an application input parameter.
